(19) United States
(12) Patent Application Publication
(10) Pub. No.: US 2026/0057246 A1
(43) Pub. Date: Feb. 26, 2026

(54) EFFICIENT HETEROGENEOUS FEDERATED LEARNING METHOD AND SYSTEM BASED ON HYBRID DISTILLATION, DEVICE, AND MEDIUM

(71) Applicant: DONGGUAN UNIVERSITY OF TECHNOLOGY, DONGGUAN (CN)

(72) Inventors: Yi Wang, DONGGUAN (CN); Senbin Liu, DONGGUAN (CN)

(21) Appl. No.: 19/371,654

(22) Filed: Oct. 28, 2025

Related U.S. Application Data
(63) Continuation of application No. PCT/CN2025/090812, filed on Apr. 24, 2025.

(30) Foreign Application Priority Data
Jul. 22, 2024 (CN) 2024109810597

(51) Int. Cl. G06N 3/098; G06N 3/048

(52) U.S. Cl. CPC G06N 3/098; G06N 3/048

(57) ABSTRACT

An efficient heterogeneous federated learning method based on hybrid distillation includes: initializing, by a server, global model parameters, and setting a preset total number of training rounds and a number of clients participating in each of the training rounds; loading local datasets in the clients respectively, performing random transformations on the local datasets to generate client distillation data for the clients, sampling multiple sub-networks from an original network of each client, training each sub-network on the client distillation data to obtain updated local model parameters of each client, and uploading the updated local model parameters to the server; and receiving, by the server, the updated local model parameters, performing, by the server, server distillation based on the updated local model parameters and a preset auxiliary dataset to obtain updated global model parameters and an updated global model, and sending, by the server, the updated global model to the clients.

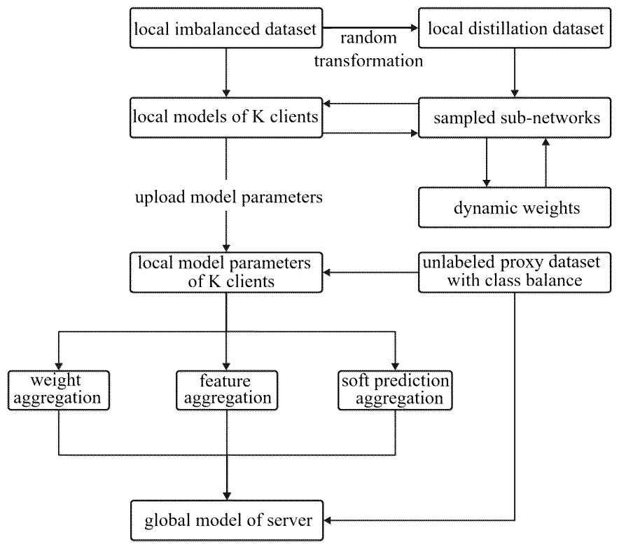

### TECHNICAL FIELD

The disclosure relates to the technical field of federated learning, and more particularly to an efficient heterogeneous federated learning method based on hybrid distillation, an efficient heterogeneous federated learning system based on hybrid distillation, a device, and a medium.

### BACKGROUND

With the improvement of computer computing power, machine learning, as a technology for analyzing and processing massive amounts of data, has been widely used in human society. However, there are data barriers between different industries and departments, leading to the formation of “isolated data islands” that cannot be safely shared, and machine learning models trained solely on the independent data of respective departments cannot achieve global optimization. The federated learning technology is proposed to solve this problem. By transferring the data storage and model training stages of machine learning to local users and only exchanging model updates with a central server, the federated learning technology effectively safeguards user privacy and security, and has been widely used in practice and has achieved good results. However, it also brings new challenges, that is, the data distribution of different parties is usually non-independent and identically distributed (non-iid). When clients possess heterogeneous data, local models often diverge from each other during training, causing client drift. Therefore, directly aggregating model parameters and updates will lead to a significant decline in the performance of the global model.

Since the problem of data heterogeneity was put forward, many methods have been proposed to alleviate various problems brought about by data heterogeneity. Existing federated learning solutions for data heterogeneity among different clients can be divided into three categories. The first category is a data-level method, which smooths the statistical heterogeneity of local client data through private data processing, such as data augmentation and external data. The second category is a model-level method, which operates at the model level, aiming to learn a local model for each client that adapts to its private data distribution while learning global information. This mainly includes adding regularization, combining contrastive learning or meta-learning, improving consistency, and sharing part of the structure, etc. The third category is a server-level method, which requires server participation, such as client selection or client clustering.

Combining the federated learning with knowledge distillation, that is, federated distillation, can use external data sources and knowledge transfer to improve the performance of federated learning in heterogeneous environments. The federated distillation belongs to both data-level and model-level methods. There are currently two main combination ways, one is client distillation, and the other is server distillation. In the client distillation, each client obtains an average soft prediction from all clients to constrain local updates and prevent falling into local optimum. However, data exchange between clients is required, which may lead to privacy leakage and make it vulnerable to poisoning attacks from malicious clients. In the server distillation, after the server aggregates client models, it fine-tunes the global model using the average soft prediction output by the auxiliary dataset. However, existing server distillation methods only use soft predictions to learn global knowledge, and rely on the set of outputs from local predictors for distillation, making them sensitive to misleading and ambiguous knowledge injected by poorly performing local models. Sharing soft predictions will exacerbate this problem.

### SUMMARY

The disclosure aims to provide an efficient heterogeneous federated learning method based on hybrid distillation, an efficient heterogeneous federated learning system based on hybrid distillation, a device, and a medium to address the above problems in the related art.

In order to achieve the above purposes, the disclosure provides an efficient heterogeneous federated learning method based on hybrid distillation, including:
step 1, initializing, by a server, global model parameters, and setting a preset total number of training rounds and a number of clients participating in each of the training rounds;
step 2, loading local datasets in the clients respectively, performing random transformations on the local datasets to generate client distillation data for the clients, sampling multiple sub-networks from an original network of each of the clients, training each of the multiple sub-networks based on the client distillation data of each of the clients to obtain updated local model parameters of each of the clients, and uploading the updated local model parameters to the server;
step 3, receiving, by the server, the updated local model parameters of each of the clients, performing, by the server, server distillation based on the updated local model parameters of each of the clients and a preset auxiliary dataset to obtain updated global model parameters and an updated global model, and sending, by the server, the updated global model to the clients; and repeating step 2 to step 3 until the updated global model converges.

In an embodiment, the efficient heterogeneous federated learning method further includes: applying the updated global model in various fields including finance, healthcare, mobile devices, intelligent transportation, the Internet of Things (IoT), and education. For example, different banks or payment institutions can jointly train the updated global model as a fraud detection model; or various hospitals can jointly train the updated global model as a model for pathological image analysis or magnetic resonance imaging (MRI) segmentation.

Specifically, a step of applying the updated global model in healthcare includes: deploying the global updated global model in a picture archiving and communication system (PACS), inputting examination data of a patient such as a computed tomography (CT) image or an MRI image to the updated global model, generating and displaying, by the updated global model, an analysis result and a treatment recommendation based on the examination data of the patient, and performing clinical treatment on the patient based on the analysis result and the treatment recommendation to facilitate curing the patient.

In an embodiment, the efficient heterogeneous federated learning method further includes: using the updated global model in image classification applications in scenarios with statistical heterogeneity and multimodality. For example, in the privacy-sensitive medical field, patients' examination data may come from different modalities such as X-rays, CT scans, and MRIs. In smart home IoT environments, human activities can be recorded through infrared images or RGB cameras installed in rooms. In intelligent transportation and autonomous driving scenarios, similar to mechanisms like Tesla's, driving behaviors from different vehicles are used to update the central model, enhancing the stability of autonomous driving. The modal data held by different clients may be of a single modality or a combination of multiple modalities.

In an embodiment, the performing random transformations on the local datasets includes: performing scaling and rotating on the local datasets to obtain the client distillation data for the clients.

In an embodiment, the multiple sub-networks have different network score widths.

In an embodiment, the training each of the multiple sub-networks based on the client distillation data of each of the clients includes:
calculating a Kullback-Leibler (KL) divergence between a softmax output of each of the multiple sub-networks and an original softmax output of a local model of a corresponding one of the clients as a distillation loss, and dynamically assigning weights for each of the multiple sub-networks based on prediction confidence of each of the multiple sub-networks; and
updating, based on the distillation loss and a traditional cross-entropy loss, local model parameters of each of the clients by using an optimization algorithm to obtain the updated local model parameters of each of the clients.

In an embodiment, step 3 specifically includes:
receiving, by the server, the updated local model parameters of each of the clients from the clients, and preforming, by the server, weight aggregation on the updated local model parameters of each of the clients to obtain a global model; and
performing, based on the preset auxiliary dataset and by using a combination of soft prediction distillation and feature distillation, distillation on the global model to obtain the updated global model parameters and the updated global model, and sending the updated global model back to the clients.

An efficient heterogeneous federated learning system based on hybrid distillation includes: an initialization module, a client distillation module, and a server distillation module.

The initialization module is configured to make a server initialize global model parameters, and set a preset total number of training rounds and a number of clients participating in each of the training rounds.

The client distillation module is configured to load local datasets in the clients respectively, perform random transformations on the local datasets to generate client distillation data for the clients, sample multiple sub-networks from an original network of each of the clients, train each of the multiple sub-networks based on the client distillation data of each of the clients to obtain updated local model parameters of each of the clients, and upload the updated local model parameters to the server.

The server distillation module is configured for the server to receive the updated local model parameters of each of the clients, perform server distillation based on the updated local model parameters of each of the clients and a preset auxiliary dataset to obtain updated global model parameters and an updated global model, and send the updated global model to the clients. The client distillation module and the server distillation module are further configured to repeat above steps until the updated global model converges.

In an embodiment, each of the initialization module, the client distillation module, and the server distillation module is embodied by at least one processor and at least one memory coupled to the at least one processor, and the at least one memory stores computer programs executable by the at least one processor.

An electronic device includes: a memory and a processor. The memory is configured to store a computer program, and the processor is configured to execute the computer program to make the electronic device implement the efficient heterogeneous federated learning method based on hybrid distillation.

A non-transitory computer-readable storage medium is stored with a computer program, and the computer program is configured to, when executed by a processor, implement the efficient heterogeneous federated learning method based on hybrid distillation.

The technical effects of the disclosure are as follows.

The disclosure proposes a two-stage learning scheme, composed of client self-distillation and server integrated distillation, to reduce local overfitting and enhance the model aggregation and generalization performance of federated learning on heterogeneous and long-tail client data. This scheme requires no information exchange between clients and no joint optimization of the global data distribution, thereby preventing privacy leakage.

The server distillation method proposed by the disclosure can achieve better representation learning and a flatter loss landscape to fine-tune the aggregated model, both of which contribute to improving the accuracy of the global model under varying degrees of data heterogeneity and different numbers of clients.

The method designed in the disclosure not only overcomes the heterogeneity issue in federated learning, but also enhances communication efficiency and attack robustness while avoiding privacy leakage.

The disclosure addresses the optimization of the efficiency and reliability of federated learning under heterogeneous data scenarios from two perspectives: statistical heterogeneity and modal heterogeneity. It effectively solves the issues of decreased performance and low communication efficiency in federated learning in practical scenarios, exploring more reliable application pathways for the implementation of federated learning in fields with multimodal image data heterogeneity, such as medical image processing and smart homes. The main benefits include: 1) better adaptation to the statistical heterogeneity issue of inconsistent training data distribution across clients, 2) improved prediction accuracy and training efficiency of the global model of the server, 3) reduced communication overhead between the server and the clients, and 4) better protection of user data privacy.

### BRIEF DESCRIPTION OF DRAWING

In order to provide a clearer explanation of embodiments of the disclosure or the technical solutions in the related art, a brief introduction will be given to the drawing required for the embodiments. It is apparent that the drawing described below is only an embodiment of the disclosure. For those skilled in the art, other drawings can be obtained based on the drawing without creative labor.

The accompanying drawing, which forms a part of the disclosure, is used to provide further understanding of the disclosure. The illustrative embodiments and their explanations of the disclosure are used to explain the disclosure and do not constitute undue limitation of the disclosure.

FIGURE illustrates a flowchart diagram according to an embodiment of the disclosure.

### DETAILED DESCRIPTION OF EMBODIMENTS

Various exemplary embodiments of the disclosure are now described in detail, which should not be construed as limiting the disclosure, but rather as a more detailed description of certain aspects, features, and embodiments of the disclosure.

It should be understood that the terms used in this disclosure are only for describing specific embodiments and are not intended to limit the disclosure. In addition, for the numerical range in the disclosure, it should be understood that each intermediate value between the upper and lower limits of the range is also specifically disclosed. Any intermediate value within any stated value or range, as well as any smaller range between any other stated value or intermediate value within the range, are also included in the disclosure. These smaller upper and lower limits can be independently included or excluded within the range.

Unless otherwise specified, all technical and scientific terms used herein have the same meanings as those commonly understood by those skilled in the art of the disclosure. Although the disclosure only describes exemplary methods, any method similar or equivalent to those described herein may also be used in the implementation or testing of the disclosure. All references mentioned in this specification are incorporated by reference for the purpose of disclosing and describing methods related to said references. In case of conflict with any incorporated literature, the content of the specification shall prevail.

Various improvements and variations can be made to the specific embodiments in the specification of the disclosure without departing from the scope or spirit of the disclosure, which will be obvious to those skilled in the art. Other embodiments obtained from the specification of the disclosure will be obvious to those skilled in the art. The specification and embodiments of the present disclosure are only exemplary.

The terms “including”, “comprising”, “possessing”, “containing”, etc. used herein are all open-ended terms, meaning they include but are not limited to.

It should be noted that the embodiments and features in the embodiments of the present disclosure can be combined with each other without conflict. Below, the present disclosure will be described in detail with reference to the accompanying drawing and in conjunction with embodiments.

### Embodiment 1

As shown in FIGURE, an embodiment provides an efficient heterogeneous federated learning method based on hybrid distillation, including:
step 1, initializing, by a server, global model parameters, and setting a preset total number of training rounds and a number of clients participating in each of the training rounds;
step 2, loading local datasets in the clients respectively, performing random transformations on the local datasets to generate client distillation data for the clients, sampling multiple sub-networks from an original network of each of the clients, training each of the multiple sub-networks based on the client distillation data of each of the clients to obtain updated local model parameters of each of the clients, and uploading the updated local model parameters to the server;
step 3, receiving, by the server, the updated local model parameters of each of the clients, performing, by the server, server distillation based on the updated local model parameters of each of the clients and a preset auxiliary dataset to obtain updated global model parameters and an updated global model, and sending, by the server, the updated global model to the clients; and
repeating step 2 to step 3 until the updated global model converges.

The embodiment proposes a two-stage learning scheme, composed of client self-distillation and server integrated distillation, to reduce local overfitting and enhance the model aggregation and generalization performance of federated learning on heterogeneous and long-tail client data. This scheme requires no information exchange between clients and no joint optimization of the global data distribution, thereby preventing privacy leakage.

The server distillation method proposed by the embodiment can achieve better representation learning and a flatter loss landscape to fine-tune the aggregated model, both of which contribute to improving the accuracy of the global model under varying degrees of data heterogeneity and different numbers of clients.

The method designed in the embodiment not only overcomes the heterogeneity issue in federated learning, but also enhances communication efficiency and attack robustness while avoiding privacy leakage.

This embodiment proposes a two-stage learning paradigm for heterogeneous federated learning, i.e., federated hybrid knowledge distillation (FedHyb), which involves knowledge distillation on both a client side and a server side as two stages. Client distillation uses dynamic sub-network learning to limit local updates and reduce local overfitting, while avoiding information exchange between the clients. On the server side, a server integrated distillation scheme is proposed, and transfers aggregated client information to the global model more comprehensively across three different levels. The server distillation is guided by an unlabeled dataset with class balance as an auxiliary dataset, and the auxiliary dataset can come from a third party or a generator unrelated to client data distribution, to supervise integrated knowledge transfer. This approach enables learning more general feature representations from model aggregation and re-training the classifier with a set of balanced data, thereby achieving better final test accuracy.

Specific schemes are as follows.
1. Traditional federated learning (FedAvg): a federated learning system with K clients is considered. For a client k=1, 2, . . . , K, each client can only access its own labeled local private data Dₖ:=(x,y), where x and y represent the local private data and labels of the client k, respectively. Nₖ:=|Dₖ| represents the amount of data on the client k. The participating clients perform local training using the cross-entropy (CE) loss:

$${min}_{W} {F}_{k} ( ω ; x , y ) := \frac{1}{{N}_{k}} {\sum }_{i = 1}^{{N}_{k}} {ℒ}_{CE} ( ω ; {x}_{i}^{k} , {y}_{i}^{k} )$$

After a specified number of training rounds, the local client model parameters ωₖ=ω₁, ω₂, . . . , ω_{K} are sent to the server. The server then performs simple model aggregation through weighted aggregation to obtain the global model parameters:

$$Ω = {\sum }_{k = 1}^{K} {p}_{K} \cdot {ω}_{K}$$

where pk=|Dₖ|/|D| represents a weight ratio of the data amount of the client k to the total data amount of all clients, with

$$D := ⋃ {\{ {D}_{k} \}}_{k = 1}^{K} .$$

The server sends the global model back to the clients. This process is repeated for T rounds until convergence.
2. Client distillation process: most existing works perform local log-based distillation, which requires information exchange between clients. If a malicious client is involved, the privacy of other clients may be compromised during the collaborative learning process. To address this issue, this embodiment designs a client self-distillation scheme that is privacy-preserving and does not require information exchange or a shared public dataset between the clients. In the self-distillation process, the random transformations, including scaling and rotating, are first performed on the local data samples Dₖ to obtain client distillation data Rₘ(x). Secondly, this embodiment samples M sub-networks with different network fractional widths from the original network, denoted as Sₘ(ω), where ω represents a local client model parameter and m=1, 2, . . . , M. Then, the accumulated distillation loss of the M sub-networks is used to constrain local updates and reduce local overfitting. Specifically, this embodiment introduces the following regularization term to the traditional CE loss function to regularize the local model updates at the client k:

$${ℒ}_{k} ( ω ; x ) = {\sum }_{m = 1}^{M} KL ( {Q}_{k} ( ω ; x ) ‖ {Q}_{k} ( {S}_{m} ( ω ) ; {R}_{m} ( ω ) ) )$$

where the softmax output of the m-th sub-network trained on the corresponding client distillation dataset is denoted as Qₖ(Sₘ(ω); Rₘ(ω)), and the original softmax output of the local model of the client k is Qₖ(ω;x); and the KL divergence therebetween is calculated for alignment. The proposed client distillation involves sampling multiple sub-networks with different network fractional widths. These sub-networks are fine-tuned using the client distillation data generated by random transformations of the local datasets, enriching the learned local semantic information without leaking it to other clients.
3. Dynamic sub-network weighting: due to the different fractional widths of the sampled sub-networks and the different simple transformations of the original image, there may be performance deviations among the sub-networks. Ideally, the sub-networks with better performance should make greater contributions to the original network. Based on this, this embodiment designs a mechanism for dynamically weighting sub-network losses, which dynamically allocates loss weights to the sub-networks according to their performance. Specifically, as training progresses, each sub-network has different prediction confidence for the samples, enabling the sub-networks to dynamically contribute to the training of the original network. It is beneficial to the original network to adaptively allocate these sub-network weights, that is to say, based on the prediction outputs of different sub-networks, sub-networks with different confidence levels make different contributions to the original network in the current training. The formula is defined as:

$${β}_{m} ( ω ; x , y ) = \frac{exp ( - {ℒ}_{CE} ( {S}_{m} ( ω ) ; {R}_{m} ( x ) ) , y )}{1 + exp ( - {ℒ}_{CE} ( {S}_{m} ( ω ) ; {R}_{m} ( x ) ) , y )}$$

where [symbol] _{CE}(Sₘ(ω);Rₘ(x)),y) represents the CE loss calculated for the m-th sub-network of the client k and the original label. In this way, sub-networks with higher prediction confidence will make greater contributions during the client self-distillation process. Combining the above design, the objective function of the local model at client k is:

$${min}_{W} {F}_{k} ( ω ; x , y ) + σ {\sum }_{m = 1}^{M} {β}_{m} ( ω ; x , y ) \cdot {ℒ}_{k} ( ω ; x )$$

where the first part βₘ (ω;x,y) represents the traditional CE loss, as shown in the equation, and the second part [symbol] (ω;x) represents the accumulated knowledge distillation (KD) loss based on soft-label predictions. This process involves dynamic weighting with adaptive model regularization. The contributions of the CE loss and the KD loss are balanced using the hyperparameter σ.
4. Server distillation: due to the existence of data heterogeneity, there may be significant differences among client models (i.e., local models). Directly aggregating the client models can result in poor performance of the server model (i.e., global model). Therefore, further fine-tuning of the server model after aggregation is performed on the server side. Specifically, further distillation is performed on the server side, and an unlabeled class-balanced proxy dataset D_{S}:=x^{s} is utilized. This proxy dataset can be sourced from a third party or generated by a generator unrelated to the client data distribution. Based on the global proxy dataset, the integrated knowledge of the client models is transferred to the server model to mitigate the drift of the server model caused by data heterogeneity. To achieve better knowledge transfer, three-level aggregation is performed, including weight aggregation, soft-prediction aggregation, and feature aggregation. The weight aggregation is first performed, which is a traditional federated learning aggregation method, to obtain the global model Ω. Then, the global model Ω is fine-tuned using the proxy dataset D_{S} with soft-prediction distillation and feature distillation. The formula for soft-prediction knowledge transfer is as follows:

$${ℒ}_{logits} ( Ω ; {x}^{s} ) = KL ( \frac{1}{K} {\sum }_{k = 1}^{K} Q ( {ω}_{k} ; {x}^{s} ) ‖ {Q}_{G} ( Ω ; {x}^{s} ) )$$

where the first term in the KL divergence

$$\frac{1}{K} {\sum }_{k = 1}^{K} Q ( {ω}_{k} ; {x}^{s} )$$

represents the aggregated soft-prediction output of the uploaded client models, that is, the soft-prediction aggregation, and the second term Q_{G}(Ω;x^{s}) represents the output of the global model with the current network parameters Ω before fine-tuning. Subsequently, the knowledge transfer of feature extraction from the K clients to the server side is performed, that is, representation knowledge transfer. This is accomplished by minimizing the mean-squared error (MSE) distance between the data representation outputs of the server model and the client models. The formula for representation knowledge transfer is as follows:

$${ℒ}_{feature} ( Ω ; {x}^{s} ) = MSE ( H ( Ω ; {x}^{s} ) , \frac{1}{K} {\sum }_{k = 1}^{K} H ( {ω}_{k} ; {x}^{s} ) )$$

where the first term H(Ω;x^{s}) in the MSE represents the penultimate feature extracted by the global model Ω, and the second term

$$\frac{1}{K} {\sum }_{k = 1}^{K} H ( {ω}_{k} ; {x}^{s} )$$

represents the aggregated penultimate feature from the uploaded client models. By combining these two types of knowledge transfer, the server integrated distillation loss is as follows:

$${Ω}^{min} {ηℒ}_{logits} ( Ω ; {x}^{s} ) + {Ω}^{min} v {ℒ}_{feature} ( Ω ; {x}^{s} )$$

where η and ν are used to adjust the proportions of soft-prediction knowledge and representation knowledge.

Experiments have shown that the model trained using the scheme of the embodiment has improved accuracy compared to traditional and the latest schemes under heterogeneous and long-tail conditions in federated learning, and simultaneously has leading advantages in communication efficiency and attack robustness. The evaluation datasets used in the embodiment are the 10-class street view house numbers (SVHN) and Canadian institute for advanced research (CIFAR)-10, and the 100-class CIFAR-100.

In the embodiment, the accuracy of the global model of the server and the accuracy of the client models under conditions of 10, 20, and 50 clients are tested. The method proposed in this embodiment achieves the highest accuracy in most cases, especially for the global model of the server, is not affected by the number of clients, and could also achieve the best performance with more clients, which is closer to real-world situations. Compared with the traditional FedAvg, this embodiment achieves a gain of 11%-24% in server accuracy. Compared with the latest proposed method, this embodiment achieves a gain of 2%-19% in server accuracy.

In terms of heterogeneity, this embodiment uses the Dirichlet distribution to alter the heterogeneity of client data. By adjusting the heterogeneity factor, different levels of heterogeneity among the clients can be achieved. The smaller the heterogeneity factor, the more heterogeneous the data becomes. Experiments have shown that the method in the embodiment outperforms traditional and the latest schemes, and achieves a gain of 3%-20% under comparable heterogeneous conditions.

In terms of communication efficiency, by comparing the number of communication rounds required for this embodiment and other methods to reach a specified test accuracy, fewer communication rounds indicate higher communication efficiency. Experiments have shown that the method in the embodiment requires the fewest communication rounds for specified test accuracies, demonstrating a leading advantage in communication efficiency.

Regarding attack robustness, the embodiment employs two attack methods to evaluate the robustness against malicious clients attempting to poison the federated learning process. One of the two attack methods is the random noise (RN) attack, which generates perturbations based on a Gaussian distribution and introduces random noise during training to mislead the training process and degrade model performance. The other is the label flipping (LF) attack, which involves modifying the client dataset to conduct targeted attacks on the global model by changing the class labels of each instance in the dataset to incorrect classifications. By comparing the method in the embodiment with traditional federated learning methods and the latest methods, as the number of malicious clients (attackers) increases, the global accuracy of all methods decreases to varying degrees. However, the method in the embodiment shows the smallest decrease, indicating that the method in the embodiment significantly enhances model robustness against the two types of data-poisoning attacks.

An efficient heterogeneous federated learning system based on hybrid distillation includes an initialization module, a client distillation module, and a server distillation module.

The initialization module is configured to make a server initialize global model parameters, and set a preset total number of training rounds and a number of clients participating in each of the training rounds.

The client distillation module is configured to load local datasets in the clients respectively, perform random transformations on the local datasets to generate client distillation data for the clients, sample multiple sub-networks from an original network of each of the clients, train each of the multiple sub-networks based on the client distillation data of each of the clients to obtain updated local model parameters of each of the clients, and upload the updated local model parameters to the server.

The server distillation module is configured for the server to receive the updated local model parameters of each of the clients, perform server distillation based on the updated local model parameters of each of the clients and a preset auxiliary dataset to obtain updated global model parameters and an updated global model, and send the updated global model to the clients. The client distillation module and the server distillation module are further configured to repeat above steps until the updated global model converges.

An electronic device includes: a memory and a processor. The memory is configured to store a computer program, and the processor is configured to execute the computer program to make the electronic device implement the efficient heterogeneous federated learning method based on hybrid distillation.

A non-transitory computer-readable storage medium is stored with a computer program, and the computer program is configured to, when executed by a processor, implement the efficient heterogeneous federated learning method based on hybrid distillation.

The above is only the exemplary embodiment of the disclosure, and the scope of protection of the disclosure is not limited to this. Any changes or replacements that can be easily thought of by those skilled in the art within the technical scope disclosed in the disclosure should be included in the scope of protection of the disclosure. Therefore, the scope of protection of the disclosure should be based on the scope of protection of the claims.

What is claimed is:

1. An efficient heterogeneous federated learning method based on hybrid distillation, comprising:
step 1, initializing, by a server, global model parameters, and setting a preset total number of training rounds and a number of clients participating in each of the training rounds;
step 2, loading local datasets in the clients respectively, performing random transformations on the local datasets to generate client distillation data for the clients, sampling a plurality of sub-networks from an original network of each of the clients, training each of the plurality of sub-networks based on the client distillation data of each of the clients to obtain updated local model parameters of each of the clients, and uploading the updated local model parameters to the server;
step 3, receiving, by the server, the updated local model parameters of each of the clients, performing, by the server, server distillation based on the updated local model parameters of each of the clients and a preset auxiliary dataset to obtain updated global model parameters and an updated global model, and sending, by the server, the updated global model to the clients; and
repeating step 2 to step 3 until the updated global model converges.

2. The efficient heterogeneous federated learning method based on hybrid distillation as claimed in claim 1, wherein the performing random transformations on the local datasets comprises:
performing scaling and rotating on the local datasets to obtain the client distillation data for the clients.

3. The efficient heterogeneous federated learning method based on hybrid distillation as claimed in claim 1, wherein the plurality of sub-networks have different network score widths.

4. The efficient heterogeneous federated learning method based on hybrid distillation as claimed in claim 1, wherein the training each of the plurality of sub-networks based on the client distillation data of each of the clients comprises:
calculating a Kullback-Leibler (KL) divergence between a softmax output of each of the plurality of sub-networks and an original softmax output of a local model of a corresponding one of the clients as a distillation loss, and dynamically assigning weights for each of the plurality of sub-networks based on prediction confidence of each of the plurality of sub-networks; and
updating, based on the distillation loss and a traditional cross-entropy loss, local model parameters of each of the clients by using an optimization algorithm to obtain the updated local model parameters of each of the clients.

5. The efficient heterogeneous federated learning method based on hybrid distillation as claimed in claim 1, wherein the step 3 specifically comprises:
receiving, by the server, the updated local model parameters of each of the clients from the clients, and preforming, by the server, weight aggregation on the updated local model parameters of each of the clients to obtain a global model; and
performing, based on the preset auxiliary dataset and by using a combination of soft prediction distillation and feature distillation, distillation on the global model to obtain the updated global model parameters and the updated global model, and sending the updated global model back to the clients.

6. An efficient heterogeneous federated learning system based on hybrid distillation as claimed in claim 1, comprising:
an initialization module, configured to make a server initialize global model parameters, and set a preset total number of training rounds and a number of clients participating in each of the training rounds;
a client distillation module, configured to load local datasets in the clients respectively, perform random transformations on the local datasets to generate client distillation data for the clients, sample a plurality of sub-networks from an original network of each of the clients, train each of the plurality of sub-networks based on the client distillation data of each of the clients to obtain updated local model parameters of each of the clients, and upload the updated local model parameters to the server; and
a server distillation module, configured for the server to receive the updated local model parameters of each of the clients, perform server distillation based on the updated local model parameters of each of the clients and a preset auxiliary dataset to obtain updated global model parameters and an updated global model, and send the updated global model to the clients;
wherein the client distillation module and the server distillation module are further configured to repeat above steps until the updated global model converges.

7. An electronic device, comprising: a memory and a processor, wherein the memory is configured to store a computer program, and the processor is configured to execute the computer program to make the electronic device implement the efficient heterogeneous federated learning method based on hybrid distillation as claimed in claim 1.

8. A computer-readable storage medium, wherein the computer-readable storage medium is stored with a computer program, and the computer program is configured to, when executed by a processor, implement the efficient heterogeneous federated learning method based on hybrid distillation as claimed in claim 1.
